(19) United States
(12) Patent Application Publication
(10) Pub. No.: US 2005/0282669 A1
(43) Pub. Date: Dec. 22, 2005

(54) Belt tensioning arrangement and belt drive with such a belt tensioning arrangement

(76) Inventors: Arthur Bauer, Remshalden (DE); Michael Hoffmann, Weinstadt (DE); Walter Kerschbaum, Schorndorf (DE)

Correspondence Address: KLAUS J. BACH, 4407 TWIN OAKS DRIVE, MURRYSVILLE, PA, 15668, US

(21) Appl. No.: 11/155,758

(22) Filed: Jun. 17, 2005

(30) Foreign Application Priority Data
Jun. 19, 2004 (DE) 102004029829.7

(51) Int. Cl. F16H 7/08; F16H 7/12; F16H 7/22

(52) U.S. Cl. 474/117; 474/133; 474/101

(57) ABSTRACT

In a belt tensioning arrangement and a belt drive including such a belt tensioning arrangement with a first belt tensioning structure for adjusting the belt tension of a first drive belt and a second belt tensioning structure for adjusting the belt tension of a second drive belt, wherein both drive belts are arranged in essentially parallel operating planes, the first and second belt tensioning structures are supported on a common support structure so as to form an integral belt tensioning arrangement.

### BACKGROUND OF THE INVENTION

The invention relates to a belt tensioning arrangement particularly a belt tensioning arrangement for at least two belt drive planes and a belt drive with such a belt tensioning arrangement.

In motor vehicles, generally different auxiliary equipment such as a generator, a water pump, a servo pump, a compressor and similar devices are driven by the engine of the motor vehicle. These devices are driven by a main pulley mounted on the crankshaft of the motor vehicle engine and an endless drive belt which extends around the main pulley and around driven pulleys mounted on the drive shafts of the auxiliary equipment. For the operation of the auxiliary equipment and the life of the drive belt, it is important that the drive belt is maintained under a certain tension. For improving the operation of the auxiliary equipment and increasing the life of the drive belt, generally a spring-loaded belt tensioning arrangement is used which usually also includes a damping structure so that slippage and vibration can be compensated for or at least reduced.

It is the object of the present invention to provide a belt tensioning arrangement and belt drive which is space saving and provides for a compact arrangement of the auxiliary devices.

### SUMMARY OF THE INVENTION

In a belt tensioning arrangement and a belt drive including such a belt tensioning arrangement with a first belt tensioning structure for adjusting the belt tension of a first drive belt and a second belt tensioning structure for adjusting the belt tension of a second drive belt, wherein both drive belts are arranged in essentially parallel operating planes, the first and second belt tensioning structures are supported on a common support structure so as to form an integral belt tensioning arrangement.

With the integration of two belt tensioning structures into a common belt tensioning arrangement, a particularly compact and space-saving belt tensioning arrangement is provided. In addition, with the provision of the drive belts in two essentially parallel drive planes, the pulleys coupled by these two essentially parallel belt drives and consequently also the auxiliary devices of a vehicle which are driven by these belt drives can be mounted in a simple and space saving manner.

In a particular embodiment of the invention, the first belt tensioning structure includes a first belt tensioning lever which is pivotably supported on the support structure, a first tensioning roller rotatably supported at one end of the first tensioning lever about which the first drive belt extends and a first tensioning spring whose one end is firmly connected to the support arrangement and whose other end is attached to the end of the tensioning lever remote from the first tensioning roller for tensioning the first drive belt extending around the first tensioning roller. The second belt tensioning structure comprises a second belt tensioning lever which is pivotally supported on the support structure, a second tensioning roller rotatably mounted on one end of the second tensioning lever around which the second drive belt extends and a second tensioning spring whose one end is connected to the support structure and whose other end is connected to the end of the second tensioning lever remote from the second tensioning roller for tensioning the drive belt extending around the second tensioning roller.

Preferably, the first and the second tensioning levers have a common pivot axis on the support structure in order to provide for a particularly compact arrangement for the belt tensioning structure.

Also, preferably, the support structure is in the form of a carrier plate and the first belt tensioning structure and the second belt tensioning structure are arranged, mirror reversed, at opposite sides of the carrier plate for a most compact setup of the belt tensioning arrangement.

In a further embodiment of the invention, the first tensioning spring of the first tensioning structure and/or the second tensioning spring of the second tensioning structure include shock absorber means in order to dampen vibrations in the tensioning structure for the belts during operation.

Preferably, the first and second tensioning springs are mounted to a common support structure which is provided essentially parallel to the common pivot axis of the first and the second tensioning levers. In this way, the belt tensioning arrangement is particularly compact.

Depending on the arrangement of the various auxiliary devices of a belt drive in which the belt tensioning arrangement according to the invention is to be utilized, it is advantageous if the first and/or second belt tensioning arrangement further includes a reversing roller for guiding the belt of the first and second belt drives.

The belt tensioning arrangement according to the invention is preferably used in a belt drive for motor vehicle. It then includes a first main belt pulley which is coupled to the crankshaft of a vehicle engine, at least one auxiliary device belt pulley which is connected to the drive shaft of an auxiliary device, a first drive belt which extends around the first main belt pulley and at least one auxiliary device pulley, a second main belt pulley which is also mounted to the crankshaft of the vehicle engine, at least one further auxiliary device belt pulley which is connected to a drive shaft of an other auxiliary device, a second drive belt, which extends around the second main belt pulley and at least one other auxiliary belt pulley and the belt tensioning arrangement according to the invention for adjusting the belt tensions of the first drive belt and the belt tension of the second drive belt, wherein the operating plane of the first drive belt around the main drive belt and the auxiliary belt pulley extend essentially parallel to the operating plane of the second drive belt around the second main belt pulley and the additional auxiliary device belt pulley.

In a particular embodiment of the invention, the first and the second main belt pulley are arranged coaxially on a main belt pulley unit, which is coupled to the crankshaft of the engine. Preferably, the main belt pulley unit, which is mounted to the crankshaft of motor vehicle engine, also includes an integrated shock absorber. With this arrangement, a very compact structure for a vehicle engine with several auxiliary devices can be obtained. The above and further features and feature combinations are described below in greater detail on the basis of the accompanying drawings.

### BRIEF DESCRIPTION OF THE DRAWINGS

FIG. 1 shows schematically a belt drive of a motor vehicle in which a belt tensioning arrangement according to the invention is utilized,

FIG. 2 is a side view of an embodiment of the belt tensioning arrangement according to the invention, and

FIG. 3 is a side view of the belt tensioning arrangement shown in FIG. 2 as seen in the direction of the arrow A.

### DESCRIPTION OF A PREFERRED EMBODIMENT

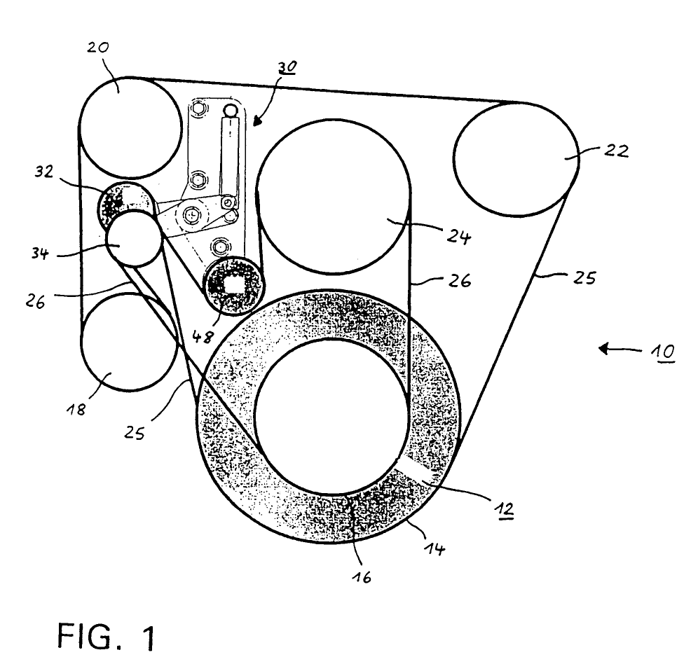

FIG. 1 shows schematically a belt drive 10 for a motor vehicle engine. The belt drive 10 comprises typically a main belt pulley unit 12 which is mounted to the crankshaft of the motor vehicle engine, several auxiliary device pulleys 18-24 which are mounted on the drive shafts of the various auxiliary devices of the motor vehicle, two drive belts 25 and 26, and a belt tensioning arrangement 30 for adjusting the tension of the two drive belts.

The main pulley unit 12 which is mounted on the crankshaft of the engine of the motor vehicle specifically comprises a first main pulley 14 and a second main pulley 16 which are arranged co-axially but displaced axially in the common main pulley unit 12. In this way, the engine can drive at the same time a first drive belt 25 which extends around the first main drive pulley 14 and a second drive belt 26, which extends around the second main drive pulley 16, whose operational plane is parallel to that of the first drive belt 25. Preferably, the main belt drive pulley unit 12 which is disposed on the crankshaft of the engine also includes an integrated vibration damper.

It is pointed out that the present invention is described as a belt tensioning arrangement for the adjustment of the belt tension of two drive belts for a belt drive of a motor vehicle engine. However, the present invention is not limited to use in connection with motor vehicles but the invention can be used rather generally also in connection with other drive means that is wherever drive belts are used. Furthermore, a drive belt tensioning arrangement is disclosed herein which includes two belt tensioning structures for two drive belts of a belt drive. But the invention is also not limited to an embodiment with two drive belts but may be used for belt drives with more than two drive belts in different drive planes.

The drive belt 25 extends around the main belt pulley 14 of the main belt pulley drive unit 12, three auxiliary device pulleys 18, 20, and 22 mounted onto the drive shafts of the auxiliary devices of the motor vehicle and a first tensioning roller 32 of the first belt tensioning structure of the integrated belt tensioning arrangement 30. The second drive belt 26, whose operating plane is essentially parallel to that of the first drive belt 25 extends around the second main belt pulley 16 of the main belt pulley drive unit 12, another auxiliary device belt pulley 24, which is mounted onto the drive shaft of another auxiliary device and around a second tensioning roller 34 and a reversing roller 48 of the second belt tensioning structure of the integrated belt tensioning arrangement 30.

The number of belt pulleys 18-22 and further auxiliary device pulleys 24 is of course not limited to that as described in connection with the example shown in FIG. 1. For example, the first drive belt 25 may extend only around one or two or more than three auxiliary pulleys 18-22; and, also the second drive belt 26 can extend around more than one additional auxiliary device pulley 24.

The auxiliary belt pulleys 28-24 are mounted onto the drive shafts of auxiliary devices of motor vehicles such as a generator, a water pump for the engine cooling system, a servo pump for the power steering, a compressor of an air conditioning system, etc . . .

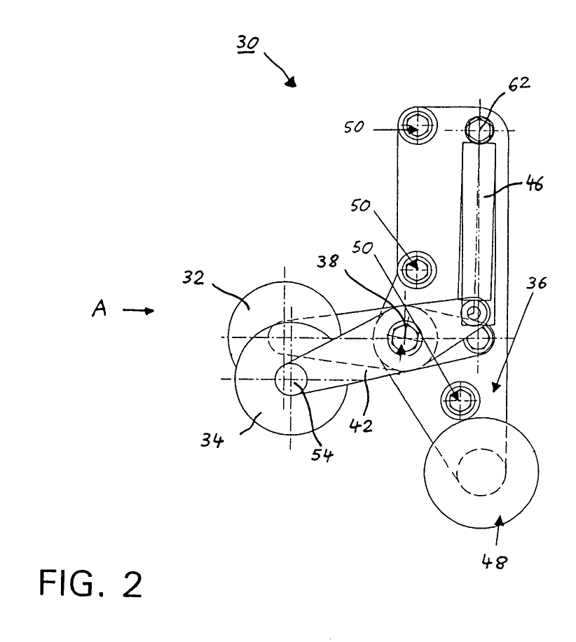

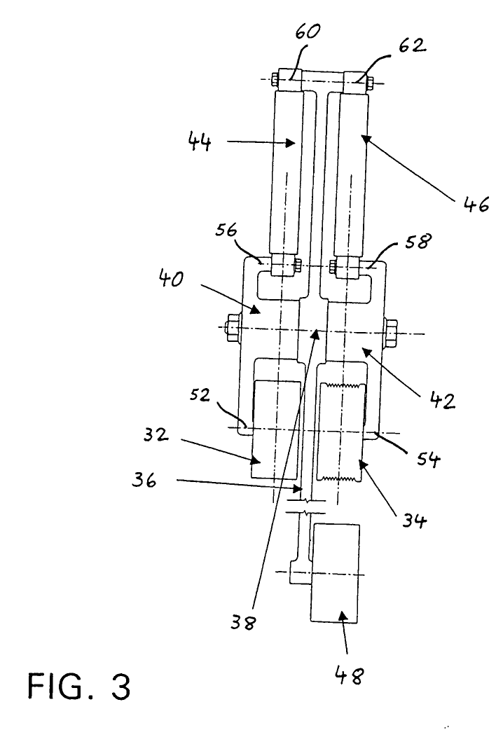

The belt tensioning arrangement 30 according to the invention will now be described in greater detail with reference to FIGS. 2 and 3.

As already mentioned, the belt tensioning arrangement 30 according to the invention comprises a first and a second belt tensioning structure for adjusting the belt tension of the first, or respectively, the second drive belts 25, 26. The first and the second belt tensioning structures are arranged in the example of FIGS. 1 and 2 in a mirror reversed fashion at opposite sides of a carrier plate 36, which serves as support structure. As apparent from FIG. 2, the carrier plate 36 is mounted for example by several mounting screws 50 to a crankcase, a device carrier or similar structure at a predetermined position in the engine compartment of the motor vehicle.

The first belt tensioning structure of the integrated belt tensioning arrangement 30 comprises as main component a first tensioning lever 40, the first tensioning roller 32 and a first tensioning spring 44. The first tensioning lever 40 is for example pivotally supported on the carrier plate 36 by a friction bearing. At one end of the first tensioning lever 40, a support structure 52 is provided on which the first tensioning roller 32 is rotatably supported around which the first drive belt 25 extends. The first tensioning spring 44, which preferably is in the form of a shock absorber, that is, in the form of an elastically damped compression spring, is mounted with one end, by way of the support member 60, on the carrier plate 36 and is connected with its other end, by way of another support member 56, to the end of the first tensioning lever 40 remote from the first tensioning roller 32. With the first tensioning lever 4 being pivotally supported, the first tensioning roller 32 is biased by the first tensioning spring 44 upwardly as shown in the embodiment of FIG. 2 in order to tension the drive belt 25 extending around the first tensioning roller 32.

The second belt tensioning structure of the integrated belt tensioning arrangement 30 is designed according to the first belt tensioning structure as described above. In particular, the second belt tensioning structure 30 comprises as main components a second tensioning lever 42, the second tensioning roller 34 and a second tensioning spring 44. The second tensioning lever 42 is supported for example via a friction bearing on the carrier plate 42 so as to be pivotable about a pivot axis 38. At one end of the second tensioning lever 42, a support structure 54 is provided on which the second tensioning roller 34 is rotatably supported. The second tensioning spring 46 which preferably also has the form of a shock absorber, that is of an elastically damped compression spring, is connected with one end thereof by way of a support structure 62 firmly to the carrier plate 36 and with its other end to the end of the tensioning lever 42 remote from the second tensioning roller 34 by way of a support structure 58. By the pivotally supported second tensioning lever 42 and the second tensioning spring 46, the second tensioning roller 34 is also biased in the upward direction of FIG. 2, in order to tension the second drive belt 26 extending around the second tensioning roller 34.

Furthermore, on the carrier plate 36 of the integrated belt tensioning arrangement 30, a reversing roller 48 is rotatably supported, which in the shown embodiment, is part of the second belt tensioning structure and around which the second drive belt 26 extends. Alternatively or additionally, the first belt tensioning structure of the integrated belt tensioning arrangement 30 may be provided with a corresponding reversing roller at the other side of the carrier plate 36. as shown in FIG. 1, this reversing roller 48 guides the second drive belt 26 between the belt tensioning pulley 34 and the additional auxiliary device pulley 24 in order to integrate the additional auxiliary device driven by the additional belt pulley 24 into the belt drive in a space saving manner.

As already mentioned and as apparent particularly clearly from FIG. 3, the two belt tensioning structures of the integrated belt tensioning arrangement 30 are arranged mirror-reversed and parallel at opposite sides of the carrier plate 36 so that they are disposed in the parallel operating planes (right and left of the carrier plate 36 in FIG. 3) of the first and second drive belt 25, 26. This provides for a particularly compact belt tensioning arrangement 30 and also a space-saving arrangement of the auxiliary units or devices of the motor vehicle.

In an even more compact and space-saving arrangement 30 of the belt tensioning structures and consequently of the whole belt drive 10 for the several auxiliary devices, the two pivot shafts for the first and the second tensioning levers 40 and 42 of the first and respectively, the second belt tensioning structures are disposed on the same axis and preferably formed by a single shaft. Furthermore, the support structures for the first and the second tensioning springs 44, 46 are formed from the carrier plate 36 preferably as a common support structure.

The particular advantages of the belt tensioning arrangement 32 according to the invention is a compact and space-saving arrangement which also results in a particularly compact belt drive 10 for several auxiliary devices such as simple installation of the belt tensioning arrangement 30 and the simple installation of the drive belts 25, 26 in the belt drive 10.

1. A belt tensioning arrangement (30) with a first belt tensioning structure for adjusting the belt tension of a first drive belt (25) and a second belt tensioning structure for adjusting the belt tension of a second drive belt (26), both arranged in essentially parallel operating planes, the first and second belt tensioning structures being supported on a common support structure (36) so as to form an integral belt tensioning arrangement (30).

2. A belt tensioning arrangement according to claim 1, wherein the first belt tensioning structure comprises a first tensioning lever (4d) supported on the support structure (36) so as to be pivotable about a pivot axes (38), a first tensioning roller (32), which is rotatably supported at one end of the first tensioning lever (40) and around which the first drive belt (25) extends, and a first tensioning spring (44) having one end firmly connected to the support structure (36) and its other end to the end of the first tensioning lever (40) opposite the first tensioning roller (32) for tensioning the first drive belt extending around the first tensioning roller (32).

3. A belt tensioning arrangement according to claim 2, wherein the second belt tensioning structure comprises a second tensioning lever (42) supported on the support structure (36) so as to be pivotable about a pivot axis (38), a second tensioning roller (34) which is rotatably supported at one end of the second belt tensioning lever (42) and around which the second drive belt (26) extends, and a second tensioning spring (46) having one end firmly connected to the support structure (36) and its other end to the end of the second tensioning lever (42) opposite the second tensioning roller (34) for tensioning the second drive belt (26) extending around the second tensioning roller (34).

4. A belt tensioning arrangement according to claim 3, wherein the pivot axis (38) of the first tensioning lever (40) and the pivot axis (38) of the second tensioning lever 942) are the same.

5. A belt tensioning arrangement according to claim 1, wherein the support structure (36) is in the form of a carrier plate, the belt tensioning structures being disposed in a mirror reversed fashion at opposite sides of the carrier plate (36).

6. A belt tensioning arrangement according to claim 2, wherein the first tensioning spring (44) of the first belt tensioning structure and the second tensioning spring (46) of the second belt tensioning structure each include shock absorbing properties.

7. A belt tensioning arrangement according to claim 3, wherein the first and second tensioning spring (44, 46) are mounted to a common support structure (60, 62) which extends essentially parallel to the common pivot axis (38) of the first and second tensioning lever (40, 42) on the support structure (36).

8. A belt tensioning arrangement according to claim 2, wherein at least one of the first and second belt tensioning structures includes a reversing roller (48) around which the respective one of the first and second drive belts (25, 26) extends.

9. A belt drive (10) for a motor vehicle having a first main belt pulley (14) which is mounted onto a crankshaft of a motor vehicle engine, at least one auxiliary device drive pulley (18-22) mounted onto a drive shaft of an auxiliary device, a first drive belt (25) which extends around the first main belt pulley (14) and the at least one auxiliary device drive pulley (18-22), a second main belt pulley (14) which is also disposed on the crankshaft of the motor vehicle engine, at least one additional auxiliary device drive pulley (24) which is mounted onto the drive shaft of an additional auxiliary device, a second drive belt (26) which extends around the second main belt pulley (16) and the at least one additional auxiliary unit drive pulley (24) and a belt tensioning arrangement (30) with a first belt tensioning structure for adjusting the belt tension of a first drive belt (25) and a second belt tensioning structure for adjusting the belt tension of a second drive belt (26), both being arranged in essentially parallel operating planes, the first and second belt tensioning structures being supported on a common support structure (36) so as to form an integral belt tensioning arrangement (30) for adjusting the belt tension of the first drive belt (25) and of the second drive belt (26), the first and second drive belts extending around the first and respectively, second main belt pulley (14, 26) and the at least one and respectively additional auxiliary device pulleys (18-24) being disposed in parallel planes.

10. A belt drive according to claim 9, wherein the first main belt pulley (14) and the second main belt pulley (16) are combined in a main belt pulley unit (12) which is mounted onto the crankshaft of the motor vehicle engine.

11. A belt drive according to claim 9, wherein the first main belt pulley (14) and the second main belt pulley (16) are provided on a main belt pulley unit (12) which is mounted onto the crankshaft of a motor vehicle engine and includes at least one vibration absorber.
